(19) United States
(12) Patent Application Publication
(10) Pub. No.: US 2009/0183623 A1
(43) Pub. Date: Jul. 23, 2009

(54) BAND MANAGER

(76) Inventor: Daniel Mueller, San Francisco, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 12/355,549

(22) Filed: Jan. 16, 2009

Related U.S. Application Data
(60) Provisional application No. 61/021,891, filed on Jan. 17, 2008.

(51) Int. Cl. G10H 1/40

(52) U.S. Cl. 84/612

(57) ABSTRACT

Providing time and event information of a musical score, including: visually providing time information of a plurality of parts of a musical score, wherein each part of the musical score includes at least one bar; and animating beats within each bar of the at least one bar to show a path between the beats and to trace the path of a time signature at a current tempo.

### CROSS-REFERENCE TO RELATED APPLICATIONS

This application claims the benefit of priority of co-pending U.S. Provisional Patent Application No. 61/021,891, filed Jan. 17, 2008, entitled “Band Manager.” The disclosure of the above-referenced provisional application is incorporated herein by reference.

### BACKGROUND

1. Field of the Invention

The present invention relates to providing time and event information of a song or musical score.

2. Background

The conventional means of providing time and event information of a song or musical score has been inadequate for users of metronomes and sequencers. For example, the actual beat point in a conventional analog metronome is not well-defined since the user must perceive the pendulum coming to a stop and changing direction. Further, most digital metronomes only provide audio and visual cues on the actual beat. Thus, a user relies on “feeling” for the position of the beat, and can get lost during various time signatures.

### SUMMARY

In one aspect, a method for providing time and event information of a musical score is disclosed. The method including: visually providing time information of a plurality of parts of a musical score, wherein each part of the musical score includes at least one bar; and animating beats within each bar of the at least one bar to show a path between the beats and to trace the path of a time signature at a current tempo.

In another aspect, a system for providing time and event information of a musical score is disclosed. The system including: a sequence generator for generating a song sequence; a time information editor configured to visually provide time information of a plurality of parts of a musical score, wherein each part of the musical score includes at least one bar; and a player configured to animate beats within each bar of the at least one bar to show a path between the beats and to trace the path of a time signature at a current tempo.

In yet another aspect, a computer-readable storage medium storing a computer program for providing time and event information of a musical score is disclosed. The computer program including executable instructions that cause a computer to: visually provide time information of a plurality of parts of a musical score, wherein each part of the musical score includes at least one bar; and animate beats within each bar of the at least one bar to show a path between the beats and to trace the path of a time signature at a current tempo.

Other features and advantages of the present invention will become more readily apparent to those of ordinary skill in the art after reviewing the following detailed description and accompanying drawings.

### BRIEF DESCRIPTION OF THE DRAWINGS

FIG. 1 shows a play mode of the band manager in accordance with one implementation of the present invention.

FIG. 2 is a flowchart showing a method of providing time and event information of a musical score in accordance with one implementation of the present invention.

FIG. 3 is a block diagram of a band manager in accordance with one implementation of the present invention.

FIG. 4 is a flowchart describing a play mode of the band manager.

FIG. 5 is a flowchart describing the process of setting or editing of the song in detail.

FIG. 6A shows an example screen of the band manager in a play mode showing basic time information in accordance with one implementation.

FIG. 6B shows an example sheet music.

FIG. 7 shows an example screen of the band manager in a play mode showing basic event information in accordance with one implementation.

FIG. 8A illustrates a representation of a computer system and a user.

FIG. 8B is a functional block diagram illustrating the computer system hosting the band manager.

### DETAILED DESCRIPTION

Certain implementations as disclosed herein provide time and event information of a musical score. After reading this description it will become apparent how to implement the invention in various alternative implementations and alternative applications. However, although various implementations of the present invention will be described herein, it is understood that these implementations are presented by way of example only, and not limitation. As such, this detailed description of various alternative implementations should not be construed to limit the scope or breadth of the present invention.

In one implementation, a band manager is configured as a portable device (with a user interface executed by software) that plays sequenced metronome arrangements of songs or musical scores. The device features a touch screen and can be mounted to music stands, microphone stands, drum hardware, or placed on a desktop. The band manager allows bands to create original songs, to store and access a large volume of cover or original songs, and to switch members while maximizing productivity during practice and recording sessions. The band manager can also be used for general practice in which a study mode allows for a large number of metronome loops and sequenced play. Users can have a standard metronome experience or work out fluidity in complex rhythm, tempo, and dynamic changes. Audio and visual cues can be turned on and off at intervals, allowing users to work on their internal metronome skills. The band manager also includes unique metronome patterns that allow users to view the part information in the measure regardless of tempo, time signature, or arrangement complexity.

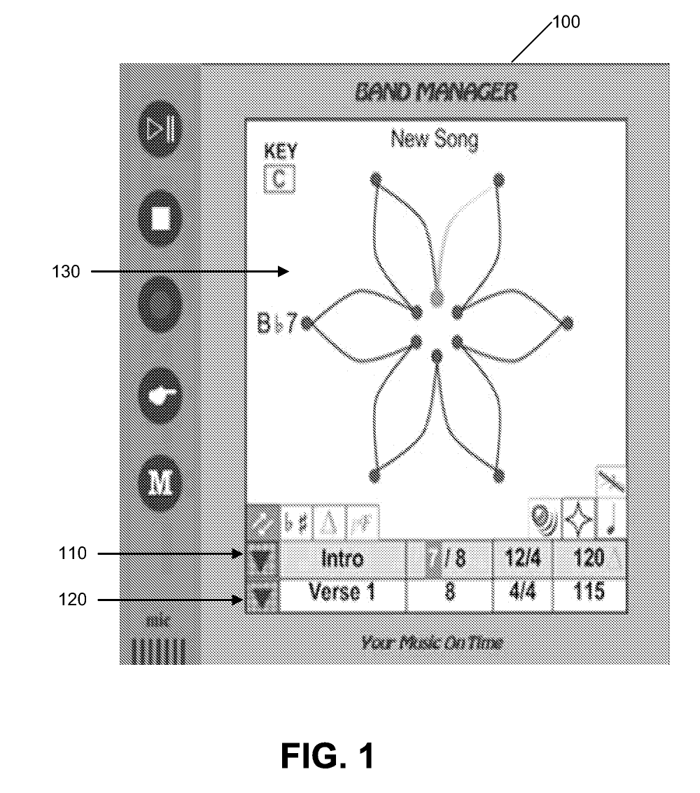

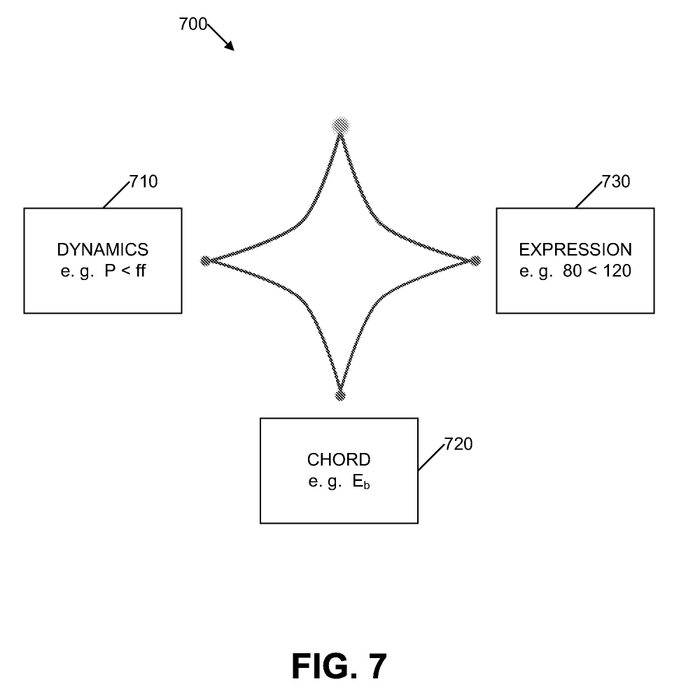

For example, FIG. 1 shows a play mode of the band manager 100 in accordance with one implementation of the present invention. In a play mode, the band manager 100 allows the user to play along with stored song sequences for accurate practice. In this mode, the user can view animating beats 130 within each bar to show a path between the beats and to trace the path of a time signature at a current tempo. The user can also view time information of a plurality of parts of a song or musical score, wherein each part of the musical score includes at least one bar. The time information includes the current part information 110 and the following part information 120 of the song. In the example implementation of FIG. 1, the current part information 110 shows the part name as Intro, the bar status as being on the seventh measure of eight measures, the time signature as 12/4, and the current tempo as 120. The next part information 120 shows the part name as Verse 1, the bar information as having eight bars in the part, the time signature at 4/4, and the tempo changed to 115. The play mode also displays the event information including dynamics, chord, and expression, which are explained below in detail (see FIG. 7). The band manager also includes an edit mode which is explained below in detail.

The advantages of the band manager include features such as: (1) the current time signature is viewed in one simple view; (2) each beat is visible with the linear path between beats; (3) the initial beat is clearly defined; (4) a traveling visual icon traces the path of the time signature, at the current tempo, in one fluid motion throughout the entire measure, which provides an analog sense of timing; (5) all time signatures can be explored with the connecting path to the first beat being distinct so that the user does not get lost in unfamiliar time signatures or complicated rhythms, which frees the user to explore rhythm within the whole measure regardless of time signature; (6) the beat is visually shown from note to note for the whole measure regardless of time signature changes so that the user is always aware of the location of the first beat, which can take place over any number of time signature changes defined by the user; (7) multiple band manger units can be linked together so that all band members can benefit from knowing the location of the current beat and the current part in the song sequence, and the next part; (8) a user can set tempo changes for song sections, per measure, or over a period of beats or measures, including between beats, which are displayed to show tempo changes in action as well as upcoming tempo changes; (9) a user can define key signatures, dynamics, musical notes, chords, and text based notes.

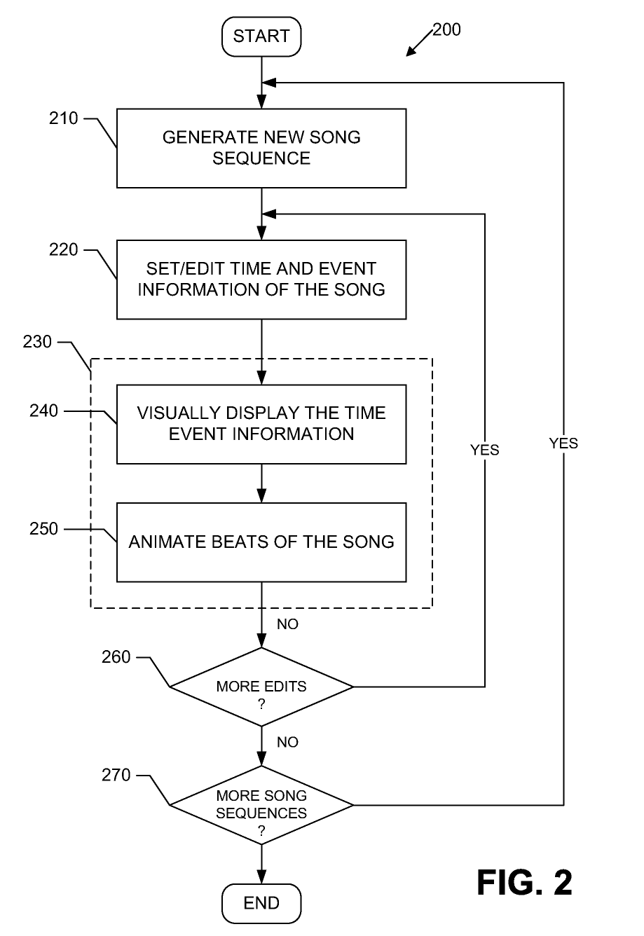

FIG. 2 is a flowchart 200 showing a method of providing time and event information of a musical score in accordance with one implementation of the present invention. At 210, a sequence for a song is generated. Time and event information of the song is then set or edited, at 220.

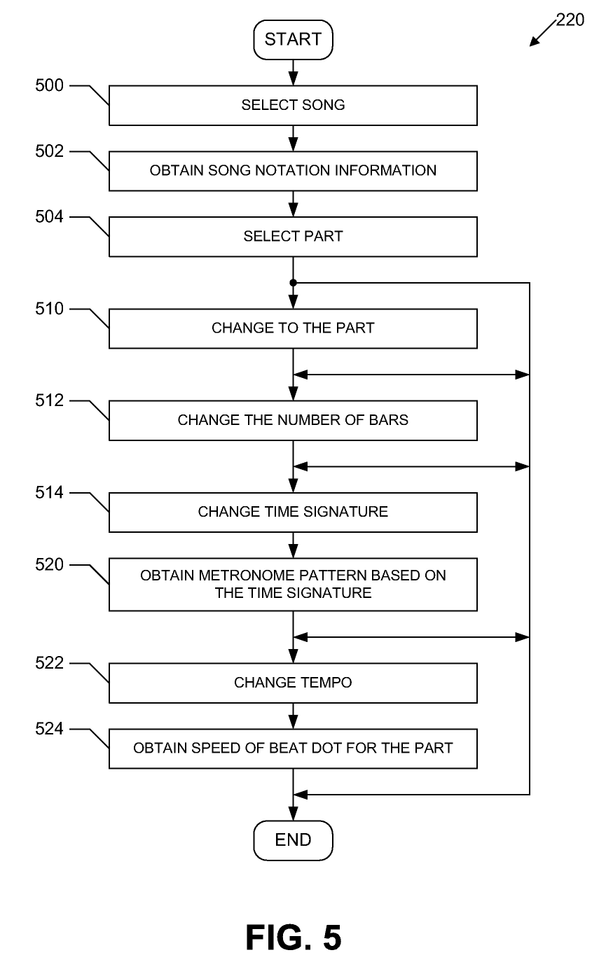

In one implementation, the process of setting or editing of the song (an edit mode) is further described in detail with a flowchart 220 in FIG. 5. Initially, a song to be set or edited is selected, at 500. Song notation information is then obtained, at 502. At 504, a part to be set or edited is selected. The selected part is edited, at 510. The number of bars is set or edited, at 512, and the time signature is set or edited, at 514. At 520, the metronome pattern is obtained based on the time signature. The tempo is set or edited, at 522, and the speed of the beat dot for the part is obtained, at 524.

Referring back to FIG. 2, set or edited time and event information is then played by the band manager (a play mode), at 230. In one implementation, the process of the band manager displaying the time and event information includes: visually displaying the time and event information, at 240, and animating beats of the song, at 250, in the play mode 230.

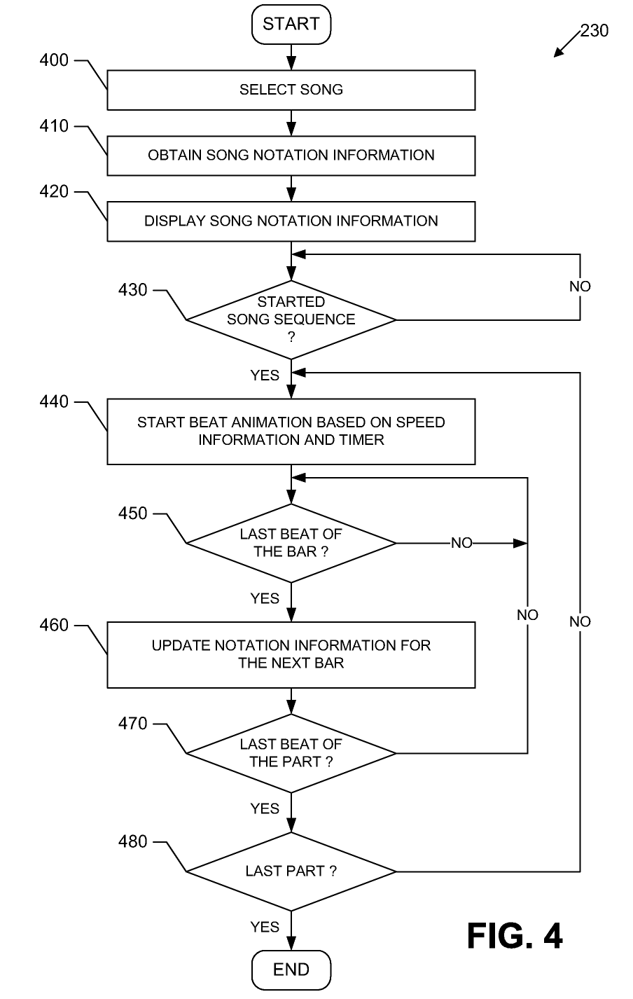

In the above implementation, the play mode of the band manager is further described in detail with a flowchart 230 in FIG. 4. Initially, a song to be played is selected, at 400. Song notation information is then obtained, at 410. At 420, the obtained song notation information is displayed. Beat information is started based on speed information and timer, at 440, when it is determined (at 430) that the song sequence has started. The notation information is updated for the next bar, at 460, when it is determined (at 450) that the last beat of the bar has been reached. The steps 450 and 460 are repeated when it is determined (at 470) that the last current beat is not the last beat of the part. When it is determined (at 480) that the current part is not the last part, the process is looped back to 440 to start the beat information again based on speed information and timer. Otherwise, the process is terminated. The speed of the animation can change during the same bar or part, and the current tempo is updated as the speed changes.

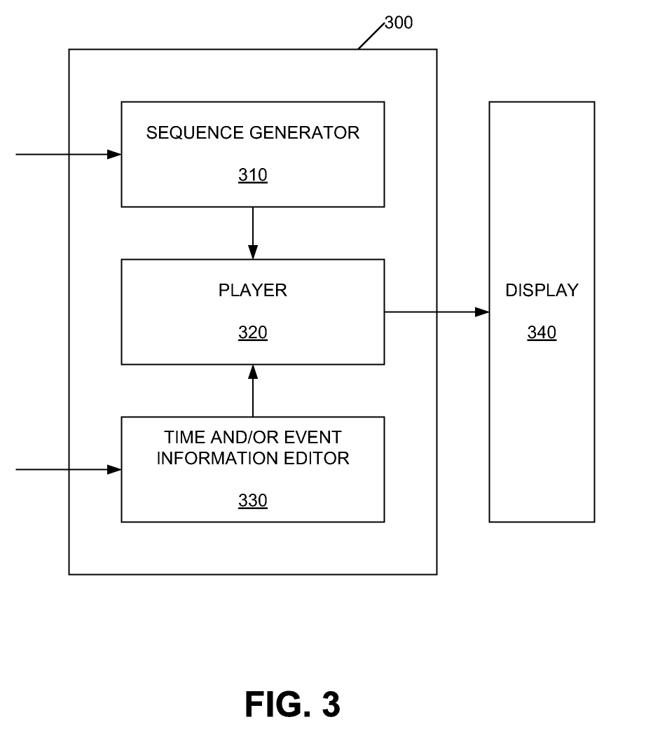

FIG. 3 is a block diagram of a band manager 300 in accordance with one implementation of the present invention. The band manager 300 provides time and event information of a musical score. In the illustrated implementation, the band manager 300 includes a sequence generator 310, a player 320, and a time/event information editor 330. The sequence generator 310 generates a sequence of a song. The time/event information editor 330 sets or edits the time and/or event information of the song.

In one implementation, the time/event information editor 330 includes: a processor for processing executable instructions for setting or editing of the song sequence generated by the sequence generator 310; and a storage memory. The instructions include: (1) selecting a song to be set or edited; (2) obtaining song notation information; (3) selecting a part to be set or edited; (4) setting or editing the part; (5) setting or editing the number of bars; (6) setting or editing the time signature; (7) obtaining the metronome pattern based on the time signature; setting or editing the tempo; and obtaining the speed of the beat dot for the part.

In the illustrated implementation of FIG. 3, the player 320 plays the time and/or event information set or edited by the time/event information editor 330. In one implementation, the player 320 displays the time and/or event information on a display 340. In this implementation, the player 320 includes: a processor for processing executable instructions for playing the time and event information set or edited by the time/event information editor 330; and a storage memory.

In one implementation, the instructions include: (1) visually displaying the time and event information; and (2) animating beats of the song. In another implementation, the instructions include: (1) selecting a song to be played; (2) obtaining song notation information; (3) displaying the obtained song notation information; (4) starting beat information based on speed information and timer when it is determined that the song sequence has started; (5) updating the notation information for the next bar when it is determined that the last beat of the bar has been reached; and (6) repeating certain instructions until the last beat of the last part has been played.

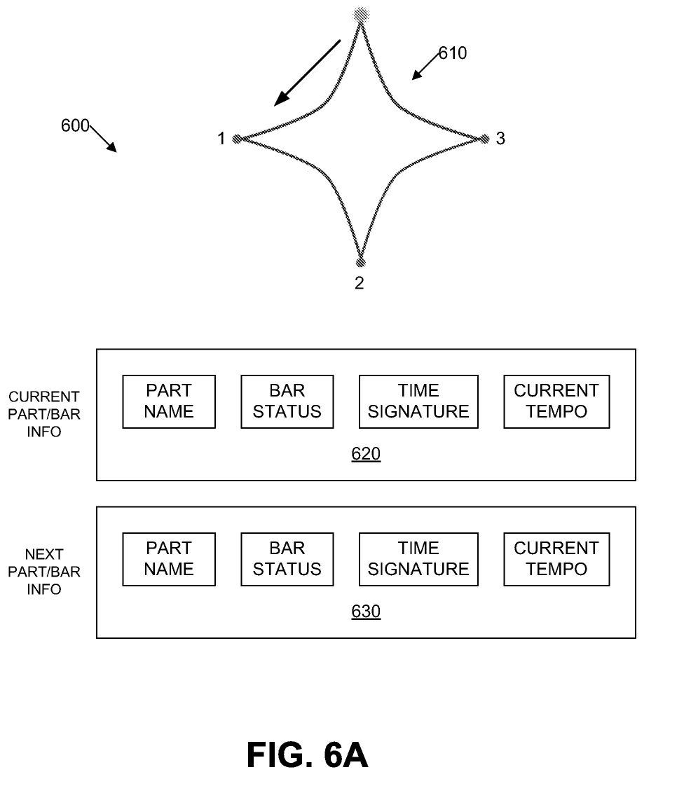

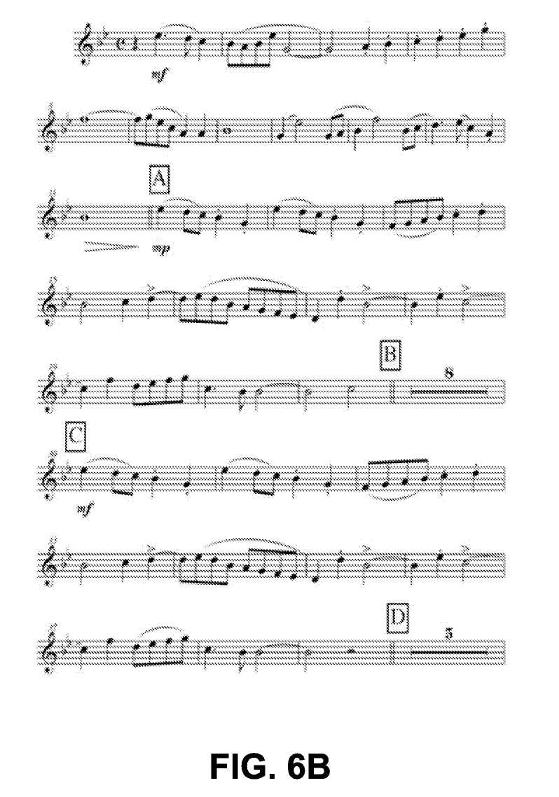

FIG. 6A shows an example screen 600 of the band manager in a play mode showing basic time information in accordance with one implementation. The screen 600 shows a metronome pattern 610 with animating beats within each bar to show a path between the beats and to trace the path of a time signature at a current tempo. The screen 600 also shows the time information including the current part information 620 and the next part information 630 of the song. In the illustrated implementation of FIG. 6A, the current part information 620 includes the part name, the bar status, the time signature, and the current tempo. The next part information 630 includes the part name, the bar information, the time signature, and the tempo.

In the illustrated implementation of FIG. 6A, a bar belongs to a part. Each part has certain time signature which can be different between bars in the same part. The tempo can change in the same bar. For example, in the sheet music shown in FIG. 6B, there are Parts A, B, C, and D. Part A includes ten bars.

FIG. 7 shows an example screen 700 of the band manager in a play mode showing basic event information in accordance with one implementation. In the illustrated implementation of FIG. 7, the screen 700 shows the metronome pattern and the event information around the pattern. The event information includes dynamics 710, chord 720, and expression 730. These information 710, 720, 730 can be positioned at beat spots to show when the events occur.

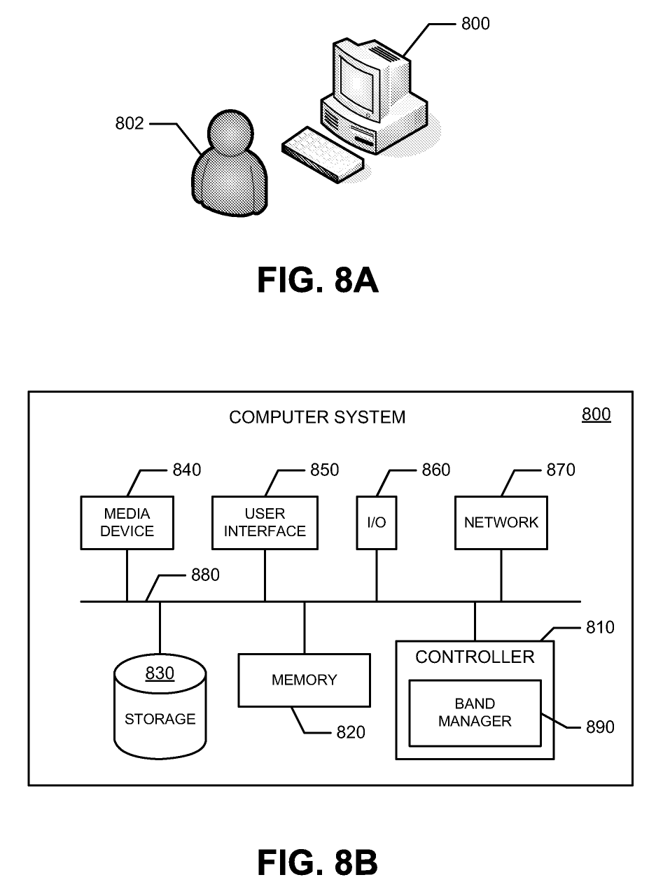

FIG. 8A illustrates a representation of a computer system 800 and a user 802. The user 802 uses the computer system 800 to store and execute the band manager which provides time and event information of a musical score.

FIG. 8B is a functional block diagram illustrating the computer system 800 hosting the band manager 890. The controller 810 is a programmable processor and controls the operation of the computer system 800 and its components. The controller 810 loads instructions (e.g., in the form of a computer program) from the memory 820 or an embedded controller memory (not shown) and executes these instructions to control the system. In its execution, the controller 810 provides the band manager 890 as a software system. Alternatively, this service can be implemented as separate hardware components in the controller 810 or the computer system 800.

Memory 820 stores data temporarily for use by the other components of the computer system 800. In one implementation, memory 820 is implemented as RAM. In one implementation, memory 820 also includes long-term or permanent memory, such as flash memory and/or ROM.

Storage 830 stores data temporarily or long term for use by other components of the computer system 800, such as for storing data used by the band manageer 890. In one implementation, storage 830 is a hard disk drive.

The media device 840 receives removable media and reads and/or writes data to the inserted media. In one implementation, for example, the media device 840 is an optical disc drive.

The user interface 850 includes components for accepting user input from the user of the computer system 800 and presenting information to the user 802. In one implementation, the user interface 850 includes a keyboard, a mouse, audio speakers, and a display. The controller 810 uses input from the user to adjust the operation of the computer system 800.

The I/O interface 860 includes one or more I/O ports to connect to corresponding I/O devices, such as external storage or supplemental devices (e.g., a printer or a PDA). In one implementation, the ports of the I/O interface 860 include ports such as: USB ports, PCMCIA ports, serial ports, and/or parallel ports. In another implementation, the I/O interface 860 includes a wireless interface for communication with external devices wirelessly.

The network interface 870 includes a wired and/or wireless network connection, such as an RJ-45 or “Wi-Fi” interface (including, but not limited to 802.11) supporting an Ethernet connection.

A system communication path 880 (e.g., a system communication bus) provides for transfers of data and control information between the media device 840, user interface 850, I/O interface 860, network interface 870, storage 830, memory 820, and controller 810.

The computer system 800 includes additional hardware and software typical of computer systems (e.g., power, cooling, operating system), though these components are not specifically shown in FIG. 8B for simplicity. In other implementations, different configurations of the computer system can be used (e.g., different bus or storage configurations or a multi-processor configuration).

Various implementations are or can be implemented primarily in hardware using, for example, components such as application specific integrated circuits (“ASICs”), or field programmable gate arrays (“FPGAs”). Implementations of a hardware state machine capable of performing the functions described herein will also be apparent to those skilled in the relevant art. Various implementations may also be implemented using a combination of both hardware and software.

Furthermore, those of skill in the art will appreciate that the various illustrative logical blocks, modules, connectors, data paths, circuits, and method steps described in connection with the above described figures and the implementations disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Accordingly, the present invention is not limited to only those implementations described above.

1. A method, comprising:
visually providing time information of a plurality of parts of a musical score,
wherein each part of the musical score includes at least one bar; and
animating beats within each bar of the at least one bar to show a path between the beats and to trace the path of a time signature at a current tempo.

2. The method of claim 1, wherein the time information includes at least one of:
a part name;
a bar status;
the time signature; and
the current tempo.

3. The method of claim 1, wherein said animating beats includes
visually tracing the path of the time signature at the current tempo.

4. The method of claim 1, wherein said animating beats includes
visually defining an initial beat and beat points.

5. The method of claim 4, wherein the beat points are defined with dots.

6. The method of claim 1, further comprising
visually providing event information of the plurality of parts of a musical score.

7. The method of claim 6, wherein the event information includes at least one of:
dynamics;
chord; and
expression.

8. The method of claim 1, further comprising:
selecting the musical score;
obtaining notation information of the musical score; and
selecting a part of the musical score to be set or edited.

9. The method of claim 8, further comprising:
setting or editing the selected part; and
setting or editing the number of bars.

10. The method of claim 8, further comprising
obtaining the speed of the beat dot for the selected part.

11. The method of claim 1, further comprising
setting or editing the time signature; and
setting or editing the tempo.

12. The method of claim 1, further comprising
obtaining a metronome pattern based on the time signature.

13. A system, comprising:
a sequence generator for generating a song sequence;
a time information editor configured to visually provide time information of a plurality of parts of a musical score,
wherein each part of the musical score includes at least one bar; and
a player configured to animate beats within each bar of the at least one bar to show a path between the beats and to trace the path of a time signature at a current tempo.

14. The system of claim 13, wherein said player includes
a beat dot tracer configured to define beat points with a dot and to visually trace the path of the time signature at the current tempo.

15. The system of claim 13, further comprising
an event information editor configured to visually provide event information of the plurality of parts of a musical score.

16. A computer-readable storage medium storing a computer program for providing time and event information of a musical score, the computer program comprising executable instructions that cause a computer to:
visually provide time information of a plurality of parts of a musical score,
wherein each part of the musical score includes at least one bar; and
animate beats within each bar of the at least one bar to show a path between the beats and to trace the path of a time signature at a current tempo.

17. The computer-readable storage medium of claim 16, wherein the instruction to animate beats includes executable instructions that cause a computer to
visually trace the path of the time signature at the current tempo.

18. The computer-readable storage medium of claim 16, wherein the instruction to animate beats includes executable instructions that cause a computer to
visually define an initial beat and beat points.

19. The computer-readable storage medium of claim 18, wherein the beat points are defined with dots.

20. The computer-readable storage medium of claim 16, further comprising executable instructions that cause a computer to
visually provide event information of the plurality of parts of a musical score.
